(19) United States
(12) Patent Application Publication
(10) Pub. No.: US 2012/0021105 A1
(43) Pub. Date: Jan. 26, 2012

(54) PROCESS FOR PRESERVATION OF ORANGES AND SIMILAR IN PLASTIC BAGS

(76) Inventor: JÚLIO CÉSAR JACOBS, BEBEDOURO (BR)

(21) Appl. No.: 12/842,718

(22) Filed: Jul. 23, 2010

(51) Int. Cl. A23B 7/148

(52) U.S. Cl. 426/326

(57) ABSTRACT

“PROCESS FOR PRESERVATION OF ORANGES AND SIMILAR IN PLASTIC BAGS” has the purpose of preserving oranges and similar in vacuum plastic packages, keeping its physicochemical features, as flavor, aroma, color and texture, for long periods of time.

### INTRODUCTION

This Patent of Invention requests deals with a new “PROCESS FOR PRESERVATION OF ORANGES AND SIMILAR IN PLASTIC BAGS”, specially a process whose purpose is packing oranges and similar in plastic bags, with modified atmosphere, keeping its physicochemical features, flavor, aroma, color and texture, for an extended period, and its use is applicable in industry and commerce, particularly in industrial kitchens, schools, supermarkets, hotels, hospitals, restaurants, etc.

### Detected Problems

A common problem with orange is a Citrus Black Spot (CBS), a disease that limits the Brazilian orange exportation for countries as Japan and European Community. Except for Citrus aurantium and its hybrids, all other varieties of oranges are susceptible to this pathogen. Guignardia citricarpa fungus, discovered by Kiely in 1948 in New South Wales Australia, is the sexual stage of the causal agent of CBS and its imperfect stage is Phyllosticta citricarpa. An important feature of CBS is its long latency period. The infection can occur by ascospores and picnidiospores. The lesion in the fruit is restricted to the flavedo (epicarp), and the fungus doesn't infect the albedo (mesocarp). Therefore, without the peel, it would be possible orange exportation to Japan and European Community.

According to Brazilian Fruit Institute—Ibraf, “the fall in orange export volumes was due to European Union impose restrictions to our oranges in natura, due to the quarantine pest blight (guinardia citricarpa)”. The result was a fall of 23% in exports of orange (Source: Gazeta Mercantil).

### Convincement

A question to which attention must be given it's with respect to Change of Eating Habits.

As an illustrative way, the introduction of peeled oranges in schools could boost domestic consumption of fruits in natura, changing, since childhood, habits for healthier foods.

They're already well known the benefits of orange to health. Eating an orange a day can prevent the manifestation of certain types of cancer. The government group Organization of Scientific and Industrial Research of British Community (CSIRO) found that consuming citrus fruits could reduce the risk of mouth, larynx and stomach cancer in more than 50%.

An extra serving of citrus a day—besides five servings of fruits and vegetables recommended—can also reduce the risk of a stroke in 19%. “Citrus fruits protect the body because of its antioxidant properties and for strengthen the immune system, inhibiting tumor growth and normalizing tumor cells”, said a CSIRO researcher.

An Australian research, based on 48 international researches on the benefits of citrus fruits to health, also discovered “convinced evidences” that these foods may reduce the risk of cardiovascular, obesity and diabetes diseases. According to Baghurst, orange is the fruit with the highest level of antioxidants, with over 170 different types of phyto-chemicals, including more than 60 flavonoids, which have anti-inflammatory and anti-tumor properties, and inhibit the formation of blood clots.

It can emphasize the benefit of selling the product without peel. Taking the fruit without peel, the consumer acquires 10% to 12% less of the product—the equivalent to its peel, thus contributing to the environment, because the peel, that would be paid by consumer and would become household garbage, could be used for other applications such as:
In the manufacture of Essential Oils. Citrus fruits—oranges, lemons, limes, tangerines, mandarins and grapefruit—are known and appreciated for millenniums because of its aroma and flavor. Citrus essential oils (EO's) are normally obtained by pressing of their peels. The citrus EO's extracted from their peels have a wide range of therapeutic and industrial applications, being very important in the global economy of citrus derivatives.
In the manufacture of Animal Feed, which can be produced from peels.
In Biodigestor installation on the property to lower the energy expenses by using orange bagasse as a source of gas production.
In the production of Organic Fertilizers through composting of peels, returning them to the orange plantations as fertilizer.

### Terminology

Brix: is a measure of quality. A brix is equivalent to approximately 1 gram of dissolved solids per 100 grams of fruit juice. Thus, for example, an orange with 9.8° Brix has 9.8 grams of solids dissolved in 100 grams of juice. The unit Brix is so popular that becomes erroneously synonymous of content of soluble solids. SST, or Brix, is a direct measure of quality: low level of SST indicates sour and/or watery fruit, tasteless, harvested immature or over-irrigation/rain. This index is used to measure quality in many fruits and vegetables—the louder index, more sweetness and with more quality. The Brix can be measured by a device specifically developed for this purpose.

Vacuum Preservation: it means to collect and remove the gases from free space of package.

Modified Atmosphere: it means provide this space, after the removing the original gases, with gas composition of CO2, N2 and Oxygen, in proportions that vary according to the feed to be packaged.

Polypropylene films are widely used by food industries, clothing manufacturers, metallurgical plants, and injected plastics, among others. Between its properties, it can be highlighted: good thermal stability; bigger sensitivity to UV light (ultraviolet) and oxidizing agents, undergoing degradation more easily; one of the lowest densities between the plastic materials, allowing greater quantity per kg; good impact strength at room temperature; excellent transparency; high chemical strength and to solvents, not being attacked by most chemicals at room temperature; extremely low water absorption; low permeability to water vapor; very low electrical conductivity.

### Theoretical

The practice of vacuum preservation and at modified atmosphere is also largely used for the storage of fruits and vegetables.

According to reports of the expert in food packaging and stability, Professor Doctor Rodrigo Rodrigues Petrus, from Department of Food Engineering of Faculty of Animal Science and Food Engineering at University of São Paulo (FZEA—USP), regarding the use of technology in modified atmosphere packaging, it's important to highlight that application of such technology depends on the food to be packaged and should be closely related to a strict temperature control of package. There is no “universal gas composition” to be applied, in other words, for each food to be packed, it has a specific composition of gases and an ideal temperature control, there is no one ready formula to be indicated and so each food should be researched and analyzed separately to determine the gas composition of the package. Should be taken into account its composition and temperature at which will be submitted by each type of food, this process has been widely used to preserve foods, raw meats, fruits and vegetables minimally processed, remembering that the gas composition and temperature control for fruits and vegetables, which are living foods, are very different from that of raw meats.

### State of the Art

Related to the preservation of fruits and vegetables, the state of art anticipates the patent number PI9902736-4, which refers to a process of treatment of fruits and vegetables, after harvest, in order to prolong their preservation life, safeguarding them from an accelerated ripening, including the use of the successive steps consisting of:
cool the interior of fruits and vegetables by shower with an aqueous composition of cooling, or immersion in an aqueous composition of cooling, this aqueous composition of cooling presents a temperature higher than 0° C. and inferior to 15° C.; and
submit, for 10 minutes at least, these fruits and vegetables to a treatment by shower with a treatment composition or by immersion in a treatment composition; this aqueous treatment composition is an aqueous composition previous taken to a temperature of 40 to 60° C.

PI0203670-3 is based, in a first step, on a cleaning of the products in a stainless steel tank with own drinking water and sanitizers. The cooling of this solution is occurred to reduce the metabolism of the products and their breathing rate respectively, which allows a long period of preservation. In a second step, occurs the removal of the excess of solution, wherein the product is put in a conveyor, or suitable object for forcing air, so that the product is compressed, ventilated or turbinated, by suction or combined together to remove excess solution products. In a third step, there was the packaging of products is performed in a gas permeable plastic film molecularly or not, or micro perforated poliolephilics or PVC coextruded or otherwise, of variable thickness according to the product being packaged.

### The Invention

Aware of prior art and its limitations and drawbacks, the inventor, professional knowledgeable of the segment in question, after studies and research, created the “PROCESS FOR PRESERVATION OF ORANGES AND SIMILAR IN PLASTIC BAGS” in subject, with the purpose of preserving oranges and similar, in plastic packages submitted to vacuum and modified atmosphere, keeping its physicochemical features for long periods, using simple procedural steps of implementation.

### Of Advantages

This invention propitiates a way of preserving the physicochemical features and the good quality of a peeled orange for a longer period of time. Therefore, it presents several advantages, especially:
Possibility of using orange in schools, as it is currently difficult to send the product fresh in the student's lunchbox, because it would need to use a knife to peel the fruit.
Use in industrial kitchens, because when orange with peel is served in industrial cafeterias after feeding, virtually most employees don't like or don't know peeling an orange, as the knife used to peel is the same offered for feeding. The fruit also has an unpleasant smell, which makes it to be changed by a dessert more practical, leaving it to consume a product often 100% natural that could improve the health in daily. The same happens in hospitals, hotels and restaurants.
Benefits to the final consumer with sales in supermarkets, distributors, etc. The population will benefit from factors such as:
Practicality—product ready for consumption at any time, consuming at the ideal refrigerator temperature (2-5 degrees).
Longevity—product has viability consumption around 15-20 days, keeping their features and organoleptic qualities.
Product with identity—the consumer buys the product with Brix information printed on the product label.

### DESCRIPTION OF FIGURES

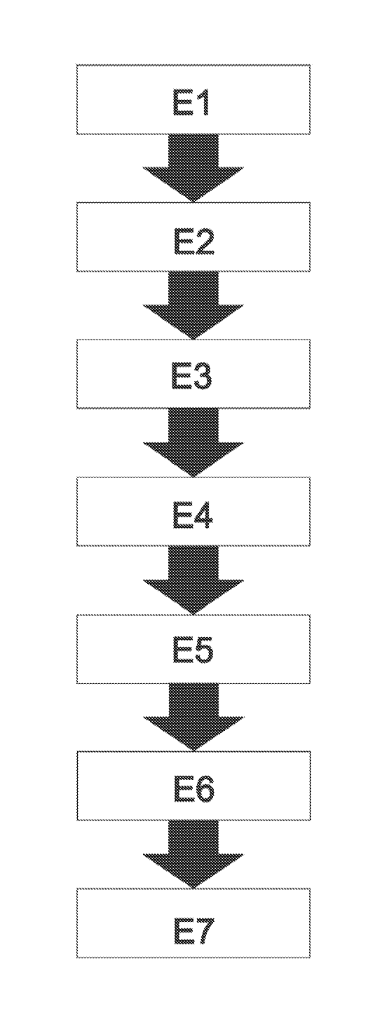

The flow of “PROCESS FOR PRESERVATION OF ORANGES AND SIMILAR IN PLASTIC BAGS” is described in the FIG. 1 attached.

### DETAILED DESCRIPTION

“PROCESS FOR PRESERVATION OF ORANGES AND SIMILAR IN PLASTIC BAGS” has the purpose of preserving oranges and similar in plastic containers submitted to vacuum and further controlled atmosphere, keeping its physicochemical features, as taste, aroma, color and texture, by a long period of time. More particularly, the process consists of, in a first step (E1), the selection of the fruits. In a second step (E2), it's made the washing and disinfection of the oranges, using chlorate solution, sodium hypochlorite of 2 to 4%. After 15 to 20 minutes, in a third step (E3), it's made rinse in running water and after, in a fourth step (E4), the cooling of oranges at a temperature between 2 and 5° C. The cooling of the orange before its peeling, in a fifth step (E5), avoids the excessive loss of shield. Thus, the fruit becomes softer, facilitating the mechanical peeling (E5), following to classification and selection in a sixth step (E6). The fruits are washed (E2) because they are harvested directly from the orchards and transported by road, thus dirt and debris can accumulate on its surface, moreover, throughout the production process, insecticides, acaricides and fungicides are used, causing the waste to remain on the peel. Proceeding to the cleaning and disinfection of the fruits, it has greater control of possible contamination of said fruit before entering the peeling room, keeping a total hygiene pattern to the consumer. The water used in washing of the fruits comes from deep wells that are settled with grants and complete examinations of water.

The peeling (E5) of the orange is performed in a fully mechanized way, with use of machines without manual intervention, thereby ensuring the quality of cleaning made in the previous step.

After peeling (E5), the fruits go by classification and selection (E6) and, in a seventh step (E7), they are only packaged products that meet the established standard quality, in other words, the fruits totally without any residue of peel, having only albedo (white part of citrus fruits).

The packing of the fruits in sealed packages (E7) has a special geometry completely leak-proof. Polypropylene packages are used for packing 04, 06 or 12 oranges by package.

Preservation is ensured in the package, because, in the packing step (E7), it's used vacuum equipment and modified atmosphere. In the vacuum preservation, the free gases of package are collected and removed; the package is further provided with modified atmosphere with gas composition of CO₂, N₂ and O₂. More specifically, in this process, to preserve oranges, it is used 5% of carbon dioxide in order to inhibit the growth of microorganisms; 2% of oxygen to keep the respiration rate and 93% of nitrogen to prevent oxidation.

What is claimed:

1. “PROCESS FOR PRESERVATION OF ORANGES AND SIMILAR IN PLASTIC BAGS”, wherein it preserves oranges and similar in vacuum plastic package with further controlled atmosphere.

2. “PROCESS FOR PRESERVATION OF ORANGES AND SIMILAR IN PLASTIC BAGS”, according to claim 1, wherein, in a first step (El), it occurs the selection of the fruits; in a second step (E2), it's made the washing and disinfection of the oranges, using chlorate solution, sodium hypochlorite of 2 to 4%; after fifteen to twenty minutes, in a third step (E3), it's made rinse in running water and after, in a fourth step (E4), the cooling of oranges at a temperature between 2 and 5° C.; in a fifth step (E5), it occurs the mechanical peeling, following to classification and selection in a sixth step (E6); after peeling (E5), the fruits go by classification and selection (E6) and, in a seventh step (E7), they are only packaged products that meet the established standard quality.

3. “PROCESS FOR PRESERVATION OF ORANGES AND SIMILAR IN PLASTIC BAGS”, according to claim 2, wherein the preservation is guaranteed in the package, because, in the packing step (E7), it's used a vacuum equipment and modified atmosphere.

4. “PROCESS FOR PRESERVATION OF ORANGES AND SIMILAR IN PLASTIC BAGS”, according to claim 3, wherein, in the vacuum preservation, the free gases of package are collected and removed; the package are further provided with modified atmosphere with gas composition of CO₂, N₂ and O₂.

5. “PROCESS FOR PRESERVATION OF ORANGES AND SIMILAR IN PLASTIC BAGS”, according to claim 4, wherein it is used 5% of carbon dioxide; 2% of oxygen and 93% of nitrogen.

6. “PROCESS FOR PRESERVATION OF ORANGES AND SIMILAR IN PLASTIC BAGS”, according to claim 2, wherein it occurs the package of the fruits in sealed polypropylene packages (E7), which have an special geometry for packing 04, 06 or 12 oranges.
